(19) United States
(12) Patent Application Publication
(10) Pub. No.: US 2024/0051197 A1
(43) Pub. Date: Feb. 15, 2024

(54) DEVICE AND METHOD FOR MANUFACTURING BOARD-LIKE INSULATING ELEMENTS

(71) Applicant: Kingspan Unidek BV, Gemert (NL)

(72) Inventors: Jurre Jan HILBERTS, Brummen (NL); Henricus Johannes Petrus HENDRIKS, Helmond (NL)

(21) Appl. No.: 18/267,936

(22) PCT Filed: Dec. 17, 2021
(86) PCT No.: PCT/IB2021/061948

§ 371 Date: Jun. 16, 2023

(30) Foreign Application Priority Data
Dec. 17, 2020 (NL) 2027137

(51) Int. Cl. B29C 44/58; B29C 44/60; E04B 1/80

(52) U.S. Cl. CPC B29C 44/585; B29C 44/60; E04B 1/80; B29K 2105/048

(57) ABSTRACT

Device for manufacturing board-like insulating elements, comprising a mould with a mould cavity for forming a board-like insulating element therein, wherein the mould cavity has an overall width, an overall height and an overall depth which correspond with respectively an overall width, an overall length and an overall thickness of the board-like insulating element, wherein the mould is configured to adjust the overall width of the mould cavity along the overall height and the overall depth of the mould cavity and/or the overall height of the mould cavity along the overall width and the overall depth of the mould cavity.

The present invention relates to a device for manufacturing board-like insulating elements. The present invention further relates to a method for manufacturing board-like insulating elements. Finally, the present invention relates to use of the device for manufacturing board-like insulating elements.

Current building processes, wherein separate structural components are transported to a building site individually and made into a structure in situ, i.e. at the building site, are under pressure.

This is due to, among other things, a growing shortage of skilled workers, an increasing need to build more quickly and cheaply, and the belief that construction of a prefabricated component and/or a prefabricated home can take place with higher quality in a conditioned factory environment than at a building site with greatly varying production conditions. Prefabrication furthermore reduces the environmental impact of building. This also applies to the production of prefabricated walls.

Prefabricated walls are generally understood to mean prefabricated wall panels which are manufactured from concrete, wood and/or other materials and which are covered at the building site with cladding and/or insulating material, such as respectively (panels of) facing stones and insulating boards or insulation blankets. Nowadays, the aim is however increasingly to realize a fully finished outer wall in the factory. It is nevertheless a great challenge to transition from a standardized product, i.e. having a fixed form and dimensions, obtained with a standardized method to automated made-to-measure production. This also applies to insulating boards.

Insulating boards are generally manufactured from expanded polystyrene foam (also referred to as EPS foam or styrofoam). A commonly used way of producing EPS foam insulating boards is manufacture by means of so-called block production. An autoclave is here filled with pre-expanded EPS beads which are then shaped into a large EPS block of for instance 1 m×1.25 m×10 m. Insulating boards or otherwise formed insulating elements are then cut from these blocks using a hot wire. This method allows the insulating boards and otherwise formed insulating elements to be cut to the desired size and shape with a hot wire. In addition to hot wire cutting the products formed by block production can also be given the desired dimension and/or shape by means of sawing and/or milling. A drawback of each of these methods is however that a relatively large amount of cutting waste is created. This may take the form of pieces of EPS foam and/or EPS dust. The methods are moreover prone to error. An insulating board or other insulating element wherein too much material has been removed may become unusable and thereby also become waste. The methods are therefore inefficient. The methods are furthermore time-consuming and labour-intensive due to the different production and processing steps, i.e. the block production and the machining. Finally, the machining of the products formed by block production may cause damage to the edges of the insulating element to be formed. This can be detrimental to the quality of the insulating element to be manufactured.

It is therefore an object of the present invention to provide a device and method for manufacturing board-like insulating elements, whereby high-quality board-like insulating elements can be manufactured in efficient manner.

According to a first aspect thereof, the present invention provides for this purpose a device of the type stated in the preamble, comprising a mould with a mould cavity for forming a board-like insulating element therein, wherein the mould cavity has an overall width, an overall height and an overall depth which correspond with respectively an overall width, an overall length and an overall thickness of the board-like insulating element, wherein the mould is configured to adjust the overall width of the mould cavity along the overall height and the overall depth of the mould cavity and/or the overall height of the mould cavity along the overall width and the overall depth of the mould cavity.

The device is preferably particularly configured to blow a quantity of pre-expanded EPS beads required for manufacture of the insulating element into the mould and then have them take on the shape of the mould cavity of the mould using steam. The mould cavity thus forms the insulating element according to the dimensions and the shape of the mould cavity.

A significant advantage of manufacture by means of the device and using the mould is that, with the same formulation (weight−raw material and the like), the insulating element has higher shearing and tensile values than insulating elements obtained by means of block production and subsequent machining. Insulating elements manufactured using the device according to the present invention therefore have a higher level of quality than insulating elements which were sawn, milled or cut with a hot wire from blocks of insulating material formed by means of block production.

Using the mould of the device a board-like insulating element can be obtained in the correct size directly, i.e. without further manufacturing steps (this in contrast to block production).

Since the mould is configured such that it is possible to adjust the overall width of the mould cavity along the overall height and the overall depth of the mould cavity and/or the overall height of the mould cavity along the overall width and the overall depth of the mould cavity, insulating elements of different sizes can be manufactured without the elements having to be machined afterward in order to be made to size. Because the insulating elements can be manufactured with the correct dimensions directly using the device, no waste is created.

The dimensions of the mould cavity are adjustable, preferably variably adjustable, in the width and/or height, so that an insulating element to be manufactured having respectively a desired width and/or a desired length can be obtained directly using the device according to the present invention by adjusting the dimensions of the mould cavity.

In this way high-quality board-like insulating elements in a variety of sizes can be obtained in efficient manner, i.e. without further processing steps. The device according to the present invention thus realizes high-grade insulating elements of high quality without producing waste, which reduces transport movements and makes further processing of the insulating elements unnecessary.

The mould is preferably configured to continuously adjust the overall width of the mould cavity along the overall height and the overall depth of the mould cavity and/or the overall height of the mould cavity along the overall width and the overall depth of the mould cavity. Owing to the continuous adjustability, insulating elements of any desired dimension can be chosen freely, albeit within width and height adjustment range of the mould, without subsequent machining of the insulating elements being necessary.

In an alternative or further preferred embodiment of the device the mould is configured to reduce the overall width and/or the overall height of the mould cavity to about 0% of respectively a maximum overall width and/or a maximum overall height of the mould cavity. Because the overall width and/or the overall height of the mould cavity can be adjusted to about 0% of respectively the maximum overall width and/or the maximum overall height of the mould cavity, insulating elements of any desired dimension can be opted for without subsequent machining being necessary, particularly when the mould is configured to adjust said overall width and/or the overall height of the mould cavity continuously.

In an alternative preferred embodiment the mould is configured to reduce the overall width and/or the overall height of the mould cavity to about 5%, to about 10%, to about 15%, to about 20%, to about 25%, to about 30%, to about 35%, to about 40%, to about 45%, to about 50%, to about 55%, to about 60%, to about 65%, to about 70%, to about 75%, to about 80%, to about 85%, to about 90% or to about 95% of respectively the maximum overall width and/or the maximum overall height of the mould cavity.

It is noted that the feature of the device of the mould being configured to adjust the overall width of the mould cavity along the overall height and the overall depth of the mould cavity and/or the overall height of the mould cavity along the overall width and the overall depth of the mould cavity does not preclude the mould from further being configured to adjust the overall width of the mould cavity along only a part of the overall height and/or only a part of the overall depth of the mould cavity and/or to adjust the overall height of the mould cavity along only a part of the overall width and only a part of the overall depth of the mould cavity.

In a preferred embodiment of the device the mould is configured to adjust the overall width of the mould cavity along the overall height and only a first portion of the overall depth of the mould cavity and/or the overall height of the mould cavity along the overall width and only a second portion of the overall depth of the mould cavity. Such a configuration of the mould makes it possible to arrange rebates, which can extend in the width and/or the length of the insulating element, in the insulating elements with the same mould, i.e. a mould wherein the overall width and overall length of the insulating elements to be manufactured can be adjusted.

In a further preferred embodiment a depth dimension of the first portion is equal to a depth dimension of the second portion. In this way rebates can be obtained with the mould, wherein the rebates extending in the width direction of the insulating element to be manufactured lie in the same plane as rebates extending in the length direction of the insulating element.

Each of the depth dimension of the first portion and the depth dimension of the second portion preferably amounts to about 50% of the overall depth. Rebates with a depth corresponding with half the thickness of the insulating element are hereby obtained in the insulating element to be manufactured.

In an alternative preferred embodiment a ratio between the depth dimension of the first portion and the depth dimension of the second portion amounts to about 0.95:0.05; about 0.90:0.10; about 0.85:0.15; about 0.80:0.20; about 0.75:0.25; about 0.70:0.30; about 0.65:0.35; about 0.60:0.40; about 0.55:0.45; about 0.55:0.45; about 0.45:0.55; about 0.40:0.60; about 0.35:0.65; about 0.30:0.70; about 0.25:0.75; about 0.20:0.80; about 0.15:0.85; about 0.10:0.90; or about 0.05:0.95.

In a preferred embodiment the first portion is located wholly on one side of the second portion, as seen in the depth direction of the mould cavity. In this way rebates which extend all the way up to one of a front surface or a rear surface of the insulating element in the thickness direction of the insulating element can be provided in the insulating element.

In an alternative embodiment one of the first and the second portion is located between two parts of the other of the first and the second portion, as seen in the depth direction of the mould cavity. In this way rebates which extend between one of a front surface or a rear surface of the insulating element can be provided in the insulating element. Such rebates enable a tongue and groove connection between two insulating elements to be mutually connected.

In an alternative or further preferred embodiment of the device the mould is configured to adjust the overall depth of the mould cavity along the overall width and the overall height of the mould cavity. The overall thickness of the insulating element can hereby be adjusted along the whole surface area of the insulating element. In addition to the width and the height of the insulating element, the thickness can therefore also be chosen using the device according to the present invention.

In a further preferred embodiment the mould is configured to continuously adjust the overall depth of the mould cavity along the overall width and the overall height of the mould cavity. By means of the continuous adjustment the depth of the shape can be determined freely within the depth adjustment range of the mould cavity.

In an alternative or further preferred embodiment the mould is configured to reduce the overall depth of the mould cavity to about 0% of a maximum overall depth of the mould cavity. Such an adjustment range provides a great freedom of choice in thicknesses of the insulating element to be manufactured.

In an alternative preferred embodiment the mould is configured to reduce the overall depth of the mould cavity to about 5%, to about 10%, to about 15%, to about 20%, to about 25%, to about 30%, to about 35%, to about 40%, to about 45%, to about 50%, to about 55%, to about 60%, to about 65%, to about 70%, to about 75%, to about 80%, to about 85%, to about 90% or to about 95% of the maximum overall depth of the mould cavity.

In a preferred embodiment of the device the mould is configured to modify a shape of the mould cavity. Because the device is configured to modify the shape of the mould cavity of the mould, insulating elements with different shapes can be obtained. This makes the device particularly suitable for manufacture of insulating elements for various insulation applications.

In a further preferred embodiment the mould is configured to modify a shape of the mould cavity such that a recess extending over the total thickness of the board-like insulating element can be arranged in the board-like insulating element. This makes it possible to modify the overall shape of the mould cavity and thereby of the insulating elements to be manufactured. Using the device insulating elements can therefore be made to fit the shape of the surface on which they must be arranged.

In a further preferred embodiment the mould is configured to arrange the recess in a corner of the board-like insulating element so that a substantially L-shaped insulating board is obtained. Such L-shaped insulating elements are eminently suitable for placing next to, preferably adjacently of, a window and/or door recess in a prefabricated wall.

In a preferred embodiment of the device the mould comprises mould walls with surfaces facing toward the mould cavity, these forming a front wall, a rear wall, a lower wall, an upper wall and two side walls, comprising a left side wall and a right side wall, of the mould cavity, and being arranged such that they collectively form a closed encasement round the mould cavity.

In a preferred embodiment at least one of the left side wall and the right side wall is movable such that a relative position of the left side wall and the right side wall is adjustable, such that the overall width of the mould cavity is adjustable by moving the at least one of the left side wall and the right side wall.

In a preferred embodiment at least one of the lower wall and the upper wall is movable such that a relative position of the lower wall and the upper wall is adjustable, such that the overall height of the mould cavity is adjustable by moving the at least one of the lower wall and the upper wall.

In an embodiment at least one of the front wall and the rear wall is movable such that a relative position of the front wall and the rear wall is adjustable, such that the overall depth of the mould cavity is adjustable by moving the at least one of the front wall and the rear wall.

In a preferred embodiment the front wall and/or the rear wall comprises a movable segment with a segment surface area which is movable relative to a remaining portion of respectively the front wall and/or the rear wall such that a depth of a portion of the mould cavity the size of the segment surface area can be reduced to zero by moving the movable segment. Owing to the movable segment, one or more recesses can be obtained locally in the insulating elements to be manufactured.

In a preferred embodiment the front wall, the rear wall, the lower wall, the upper wall and the two side walls are arranged movably such that they cannot be positioned in the area of movement of the movable segment.

In a preferred embodiment the movable segment is arranged adjacently of one of the lower wall and the upper wall and one of the two side walls, these being the left side wall and the right side wall, when the lower wall, the upper wall and the two side walls are positioned such that the size of the mould cavity is maximal. The mould cavity and the segment preferably take a rectangular form so that the segment extends along a corner of the mould cavity and a recess can be arranged in a corner of the insulating element to be manufactured corresponding with said corner. The mould cavity is preferably further formed such that such a corner recess results in an L-shaped insulating element. As elucidated above, such an L-shaped insulating element is eminently suitable for placing next to, preferably adjacently of, a window and/or door recess in a prefabricated wall.

In a preferred embodiment the one of the lower wall and the upper wall and the one of the left side wall and the right side wall of which the segment lies adjacently are disposed stationary relative to the other of the lower wall and the upper wall and the other of the left side wall and the right side wall.

In a preferred embodiment the mould further comprises a first mould half comprising first mould walls which collectively surround a first cavity forming a first portion of the mould cavity, and a second mould half comprising second mould walls which collectively form therebetween a second cavity forming a second portion of the mould cavity, wherein the first mould half and the second mould half are movable relative to each other, such that the mould is movable between respectively an open position, in which the first mould half and the second mould half are mutually separated, and a closed position, in which the first mould half and the second mould lie against each other, wherein in the closed position the first mould walls and the second mould walls lie against each other such that the first mould walls and the second mould walls collectively form the front wall, the rear wall, the lower wall, the upper wall, the left side wall and the right side wall of the mould cavity and that the first cavity and the second cavity collectively form the mould cavity of the mould, wherein the first mould walls form the front wall, a first lower wall, a first upper wall and first side walls, comprising a first left side wall and a first right side wall, and wherein the second mould walls form the rear wall, a second lower wall, a second upper wall and second side walls, comprising a second left side wall and a second right side wall, wherein the first and the second lower wall collectively form the lower wall, the first and the second upper wall collectively form the upper wall, the first and the second left side wall collectively form the left side wall and the first and the second right side wall collectively form the right side wall. It is noted that the first mould half and the second mould half being movable relative to each other comprises embodiments wherein one of the first and the second mould half is disposed fixedly and the other of the first and the second mould half is movable from and to said one of the first and the second mould half, or wherein both the first and the second mould half can be moved from and to each other. It is also noted that the first mould half and the second mould half preferably extend substantially vertically. In an alternative embodiment the first mould half and the second mould half extend substantially horizontally.

In a preferred embodiment the first mould walls and the second mould walls are movable independently of each other, such that an overall first width and/or an overall first height of the first cavity is adjustable independently of an overall second width and/or an overall second height of the second cavity, and vice versa. Because the first mould walls and the second mould walls are movable independently of each other in such a manner, insulating elements of different width and length are obtained and rebates are simultaneously arranged in the width and/or length direction in said insulating elements of different width and length. This allows great freedom in respect of the size and, of the insulating elements, the position and depth of the rebates to optionally be arranged therein.

In a preferred embodiment the first mould walls and the second mould walls are movable independently of each other, such that an overall first depth of the first cavity is adjustable independently of an overall second depth of the second cavity, and vice versa.

In a preferred embodiment at least one of the first left side wall and the first right side wall and/or at least one of the second left side wall and the second right side wall is movable such that respectively a relative position of the first left side wall and the first right side wall and/or a relative position of the second left side wall and the second right side wall is adjustable, such that respectively the first overall width of the first cavity and/or the second overall width of the second cavity is adjustable.

In a preferred embodiment at least one of the first lower wall and the first upper wall and/or at least one of the second lower wall and the second upper wall is movable such that respectively a relative position of the first lower wall and the first upper wall and/or a relative position of the second lower wall and the second upper wall is adjustable, such that respectively the first overall height of the first cavity and/or the second overall height of the second cavity is adjustable.

In a preferred embodiment the first lower wall, the first upper wall and the first side walls have the same first dimension as each other in the direction perpendicularly of the front wall, and the second lower wall, the second upper wall and the second side walls have the same second dimension as each other in the direction perpendicularly of the rear wall.

In a preferred embodiment the first dimension and the second dimension are the same.

In an alternative embodiment a ratio between the first dimension and the second dimension amounts to about 0.95:0.05; about 0.90:0.10; about 0.85:0.15; about 0.80:0.20; about 0.75:0.25; about 0.70:0.30; about 0.65:0.35; about 0.60:0.40; about 0.55:0.45; about 0.55:0.45; about 0.45:0.55; about 0.40:0.60; about 0.35:0.65; about 0.30:0.70; about 0.25:0.75; about 0.20:0.80; about 0.15:0.85; about 0.10:0.90; or about 0.05:0.95.

In a preferred embodiment the front wall and/or the rear wall comprises a feed opening for feeding steam to the mould cavity. By means of feeding steam the pre-expanded polystyrene beads in the mould cavity expand further and fuse into one whole.

In a preferred embodiment the feed opening comprises a plurality of feed ports distributed substantially evenly over the front wall and/or the rear wall, wherein the feed ports are preferably distributed in a two-dimensional array.

In a preferred embodiment the mould walls forming the lower wall, the upper wall, the left side wall and/or the right side wall are configured to close the feed ports which have come to lie outside the mould cavity due to a movement of respectively the lower wall, the upper wall, the left side wall and/or the right side wall which reduces a dimension of the mould cavity. It is hereby prevented that steam runs off outside the mould cavity and is also wasted, and that this decreases the steam pressure and steam feed quantity in the mould cavity.

In a preferred embodiment the front wall and/or the rear wall comprises a filling opening for filling the mould cavity with pre-expanded polystyrene beads. In this preferred embodiment the device is for this purpose further provided with a filling gun arranged on the filling opening. The filling gun can consequently be arranged on the first mould half and/or the second mould half.

In a preferred embodiment the filling opening comprises a plurality of filling ports distributed substantially evenly over the front wall and/or the rear wall. The filling ports are preferably distributed in a two-dimensional array. In this preferred embodiment the device is for this purpose further provided with filling guns arranged on each of the filling ports. The filling guns can consequently likewise be arranged on the first mould half and/or the second mould half.

In a preferred embodiment the device further comprises a controller which is configured to control the mould on the basis of width and length information of the board-like insulating element to be manufactured, such that an overall width and/or an overall height of the mould cavity is adjusted in accordance with the width and length information.

In a preferred embodiment the controller is further configured to control the filling guns depending on respectively the position of the first lower wall, the first upper wall and the first side walls and/or the position of the second lower wall, the second upper wall and the second side walls such that, when filling the mould cavity with pre-expanded polystyrene beads, use is made only of the filling guns which are arranged on the filling ports lying between said walls.

In a preferred embodiment the controller is further configured to receive width and length information of a plurality of board-like insulating elements to be manufactured, to create on the basis of the width and length information an arrangement from large surface area to small surface area of the board-like insulating elements to be manufactured, and to control the mould according to the arrangement such that board-like insulating elements to be manufactured are manufactured from large to small. A particular advantage of controlling the mould according to this arrangement is that the mould walls need only be moved from outside to inside, and not reciprocally, during manufacture of a batch of board-like insulating elements. This saves time during the manufacturing cycle, which increases the capacity of the device.

In a preferred embodiment the controller is further configured to control the device such that board-like insulating elements manufactured according to the arrangement are stacked on top of each other according to this same arrangement, so that the manufactured board-like insulating elements form a stack wherein the surface area of the board-like insulating elements decreases from bottom to top in the stack. A particular advantage of forming a stack of insulating elements according to this arrangement is that the largest insulating elements lie at the bottom of the stack and the smallest at the top. This provides for a stable stack, which is particularly advantageous during transport of the stack of insulating elements to for instance the assembly location, where the insulating elements must be arranged on a surface to be covered/clad therewith.

In a preferred embodiment the device is further configured to arrange a first label with legible information on a side of each of the board-like insulating elements, and the controller is further configured to control the device such that the first label on the side of each of the board-like insulating elements is arranged such that the first label of each of the board-like insulating elements in the stack lies on the same side of the stack and is legible when the first label of each of the board-like insulating elements is read from a direction perpendicularly of said same side of the stack. This makes it possible to provide each insulating element with information which is legible from a predetermined side when each of the insulating elements is arranged on the stack.

In a preferred embodiment the device is further configured to arrange a second label with legible information on a front side of the board-like insulating element, and the controller is further configured to receive first orientation information about a first orientation of a surface to be clad with the board-like insulating element and to receive second orientation information about a second orientation of the board-like insulating element relative to the surface to be clad with the board-like insulating element and on which the board-like insulating element is to be arranged, and to control the device on the basis of the first and the second orientation information such that the second label and the front side of the board-like insulating element are oriented relative to each other, and the second label is then arranged on the front side of the board-like insulating element, such that in a state wherein the board-like insulating element is arranged according to the second orientation on the surface to be clad the second label is legible when the surface to be clad is oriented according to the first orientation and the second label is read from a direction perpendicularly of the surface to be clad. This makes it possible to provide each insulating element with information which is legible when it is arranged on the surface to be clad.

In a preferred embodiment the surface to be clad is a wall of a building.

The wall is preferably a prefabricated wall.

In a preferred embodiment the board-like insulating elements are insulating boards manufactured from expanded polystyrene (EPS).

In a preferred embodiment the device is a shape moulding machine.

According to a second aspect, the present invention provides a method of the type stated in the preamble, comprising of providing a device for manufacturing board-like insulating elements, comprising a mould with a mould cavity for shaping a board-like insulating element therein, wherein the mould cavity has an overall width, an overall height and an overall depth which correspond with respectively a width, a length and a thickness of the board-like insulating element, determining the width and the length of the board-like insulating element to be manufactured, adjusting the overall width of the mould cavity along the overall height and the overall depth of the mould cavity and/or overall height of the mould cavity along the overall width and the overall depth of the mould cavity in accordance with the determined width and length of the board-like insulating element to be manufactured, and manufacturing the board-like insulating element in the adjusted mould cavity.

In a preferred embodiment of the method the mould is configured to adjust the overall width of the mould cavity along the overall height and only a first portion of the overall depth of the mould cavity and/or the overall height of the mould cavity along the overall width and only a second portion of the overall depth of the mould cavity, wherein a depth dimension of the first portion corresponds with a depth of a first rebate to be arranged in a length direction of the insulating element and a depth dimension of the second portion corresponds with a depth of a second rebate to be arranged in a width direction of the insulating element, and the method further comprises of determining a width of the first rebate and/or determining a length of the second rebate, and of adjusting the mould respectively in accordance with the determined width of the first rebate and/or in accordance with the determined length of the second rebate.

In a further preferred embodiment the depth dimension of the first portion is equal to the depth dimension of the second portion so that the depth of the first rebate is equal to the depth of the second rebate. In this way rebates can be obtained with the mould, wherein the rebates extending in the width direction of the insulating element to be manufactured lie in the same plane as rebates extending in the length direction of the insulating element.

In a further preferred embodiment each of the depth dimension of the first portion and the depth dimension of the second portion amounts to about 50% of the overall depth, so that the depth of the first rebate and the depth of the second rebate amounts to about 50% of the thickness of the board-like insulating element.

In a preferred embodiment the mould is configured to adjust the overall depth of the mould cavity along the overall width and the overall height of the mould cavity, and the method further comprises of determining the thickness of the board-like insulating element to be manufactured and of adjusting the overall depth of the mould cavity along the overall width and the overall height of the mould cavity in accordance with the determined thickness of the board-like insulating element to be manufactured.

In a preferred embodiment the mould is configured to modify a shape of the mould cavity, and the method further comprises of determining a shape of the board-like insulating element to be manufactured and of modifying the shape of the mould cavity in accordance with the determined shape of the board-like insulating element to be manufactured.

In a preferred embodiment the step of modifying the shape of the mould cavity in accordance with the determined shape of the board-like insulating element to be manufactured comprises of modifying the shape of the mould cavity such that a recess is arranged in the board-like insulating element which extends over the total thickness of the board-like insulating element.

In a preferred embodiment the recess is arranged in a corner of the board-like insulating element so that a substantially L-shaped insulating board is obtained. As elucidated above, such an L-shaped insulating element is eminently suitable for placing next to, preferably adjacently of, a window and/or door recess in a prefabricated wall.

In a preferred embodiment the recess is obtained by arranging an element in the mould cavity which locally reduces the depth of the mould cavity to zero.

In a preferred embodiment the step of determining the width and the length of the board-like insulating element to be manufactured comprises of determining a width, a length and a shape of a surface to be clad with the board-like insulating elements, of geometrically dividing the whole surface to be clad into a plurality of part-surfaces, wherein a width and a length of each of the plurality of part-surfaces are respectively not greater than and not smaller than respectively a maximum insulating element width and a maximum insulating element length and respectively a minimum insulating element width and a minimum insulating element length of an insulating element to be manufactured in the mould cavity of the mould, and of determining width and length information for each of the plurality of part-surfaces and determining the width and the length of the board-like insulating element to be manufactured in accordance with the determined width and length information. With this method a quantity of cutting waste created during further processing of the insulating element by machining is limited to minimum or reduced to zero because further processing can be dispensed with.

In a preferred embodiment the method further, following the step of determining the width and the length information for each of the plurality of part-surfaces, comprises of creating an arrangement from large surface area to small surface area of the part-surfaces of the plurality of part-surfaces, and of adjusting the overall width of the mould cavity along the overall height and the overall depth of the mould cavity and/or overall height of the mould cavity along the overall width and the overall depth of the mould cavity according to the arrangement and in each case in accordance with the determined width and length information, and of manufacturing the board-like insulating element in the adjusted mould cavity. A significant advantage of adjusting the mould cavity according to the arrangement is that the mould walls of the mould cavity will have to move substantially in only one direction, i.e. in a direction in which the mould cavity decreases, during manufacture of the different boards. This saves time, which increases the capacity of the device.

In a preferred embodiment the method further comprises of stacking the board-like insulating elements manufactured according to the arrangement on top of each other according to the arrangement, so that the manufactured board-like insulating elements form a stack wherein the surface area of the board-like insulating elements decreases from the bottom to the top of the stack. A significant advantage of stacking according to the arrangement is that the largest insulating board comes to lie at the bottom of the stack arranged on the pallet and the smallest insulating board at the top of the stack, so that the stack narrows toward the top as seen in the width direction. A stable stack of insulating boards is hereby obtained, which is advantageous during transport thereof.

In a preferred embodiment the method further comprises of arranging a first label with legible information on a side of each of the board-like insulating elements, comprising of arranging the first label on the side of each of the board-like insulating elements such that the first label of each of the board-like insulating elements in the stack lies on the same side of the stack and is legible when the first label of each of the board-like insulating elements is read from a direction perpendicularly of said same side of the stack. This makes it possible to provide each insulating element with information which is legible from a predetermined side when each of the insulating element is arranged on the stack.

In a preferred embodiment the method further comprises of arranging a second label with legible information on a front side of the or each board-like insulating element, comprising of obtaining first orientation information about a first orientation of a surface to be clad with the or each board-like insulating element and second orientation information about a second orientation of the or each board-like insulating element relative to the surface to be clad with the or each board-like insulating element and on which the or each board-like insulating element is to be arranged; and of orienting the second label and the front side of the or each board-like insulating element relative to each other, and then arranging the second label on the front side of the or each board-like insulating element, on the basis of the first and the second orientation information such that in a state wherein the or each board-like insulating element is arranged on the surface to be clad according to the second orientation the second label is legible when the surface to be clad is oriented according to the first orientation and the second label is read from a direction perpendicularly of the surface to be clad. This makes it possible to provide each insulating element with information which is legible when it is arranged on the surface to be clad.

In a preferred embodiment of the method the surface to be clad is a wall of a building.

The wall is preferably a prefabricated wall.

In a preferred embodiment of the method the board-like insulating elements are insulating boards manufactured from expanded polystyrene (EPS).

In a preferred embodiment of the method the device is a shape moulding machine.

According to a third aspect, the present invention provides for use of the device according to any one of the foregoing preferred embodiments in the manufacture of board-like insulating elements using the method according to any one of the foregoing preferred embodiments.

By means of the device and method discussed above it is possible to manufacture both substantially rectangular and substantially L-shaped insulating boards in a variety of sizes, optionally with rebates at different locations and of different widths. The device and the method thereby enable manufacture of high-quality EPS (styrofoam) insulating boards, i.e. with high shearing and tensile values, without creating cutting waste and without edges becoming damaged, since further processing of the insulating boards is no longer necessary.

The present invention will be further elucidated with reference to the following figures, which show preferred embodiments of the device and the method according to the present invention and are not intended to limit the scope of protection of the invention in any way, wherein:

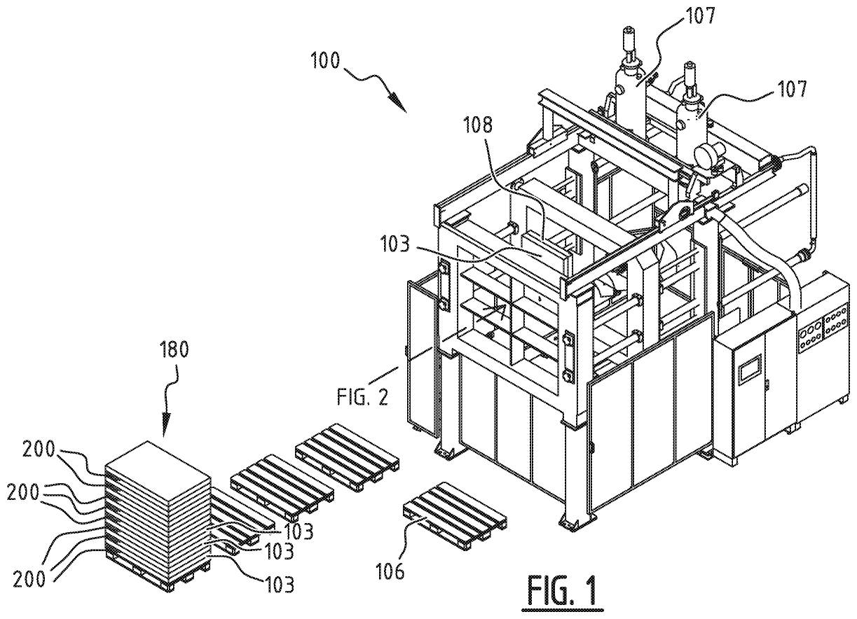

FIG. 1 shows a perspective view of a preferred embodiment of the device according to the present invention;

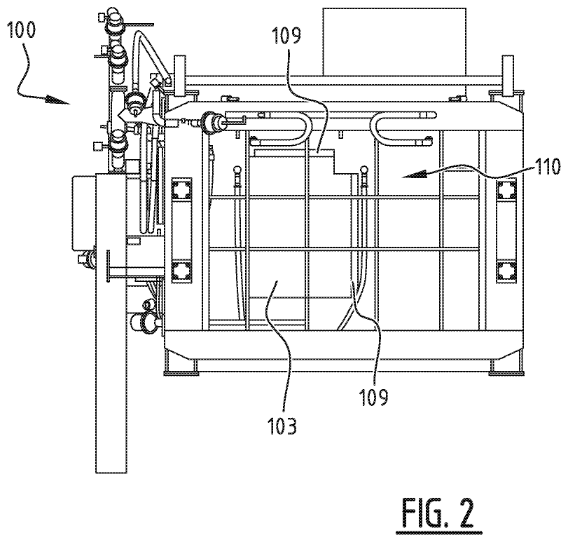

FIG. 2 shows a front view of the device of FIG. 1;

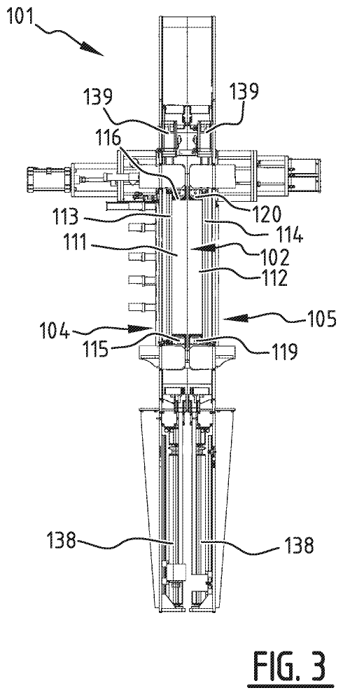

FIG. 3 shows a side view of a cross-section of the mould of the device of FIG. 1;

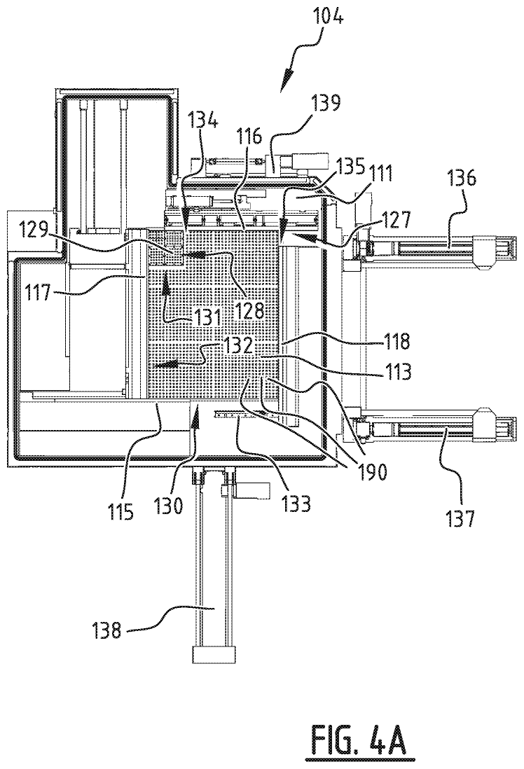

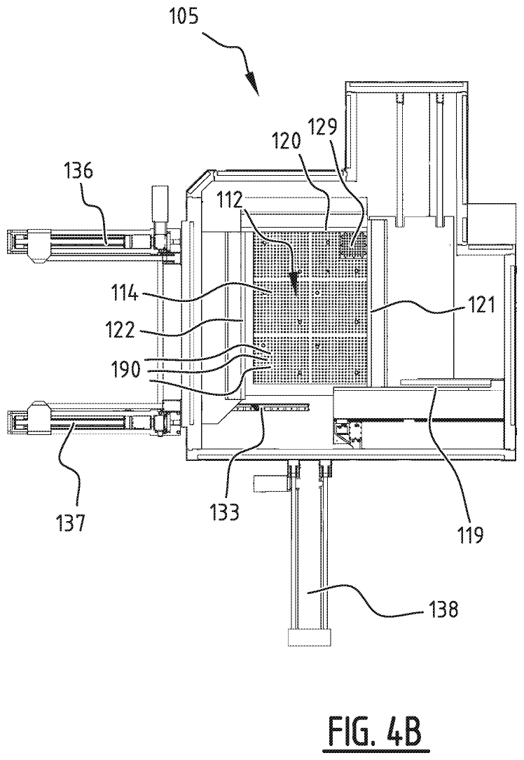

FIGS. 4A and 4B show respectively a front view and rear view of a cross-section of the mould of FIG. 3;

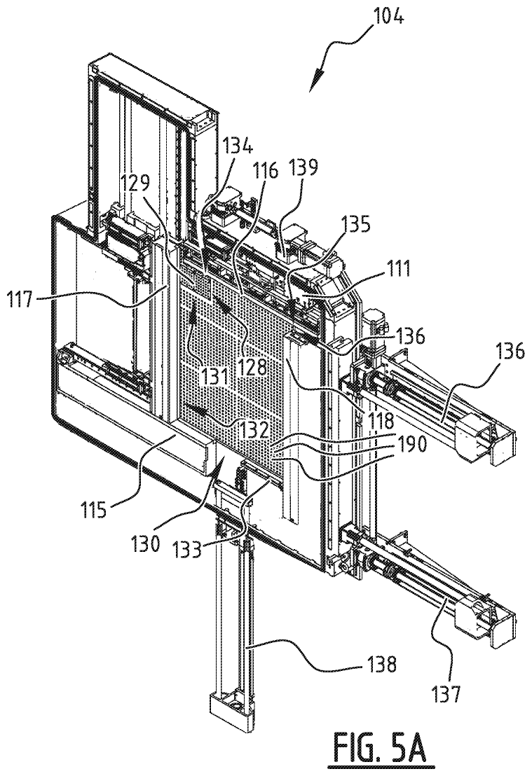

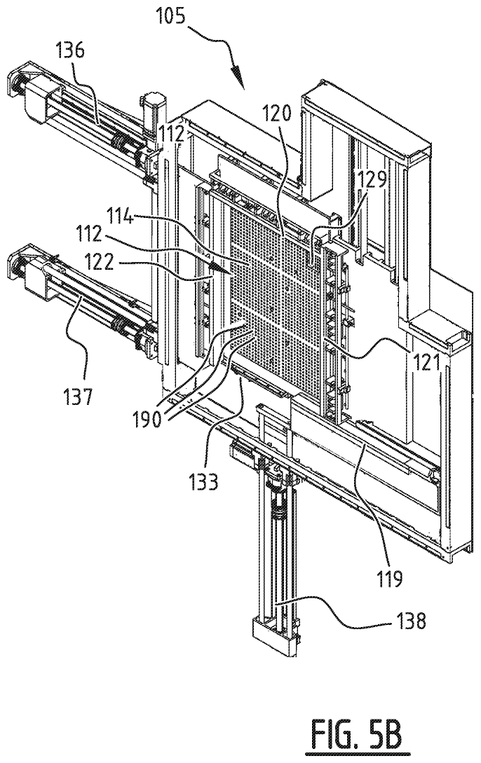

FIGS. 5A and 5B show two perspective views of the cross-section of the mould of FIG. 4;

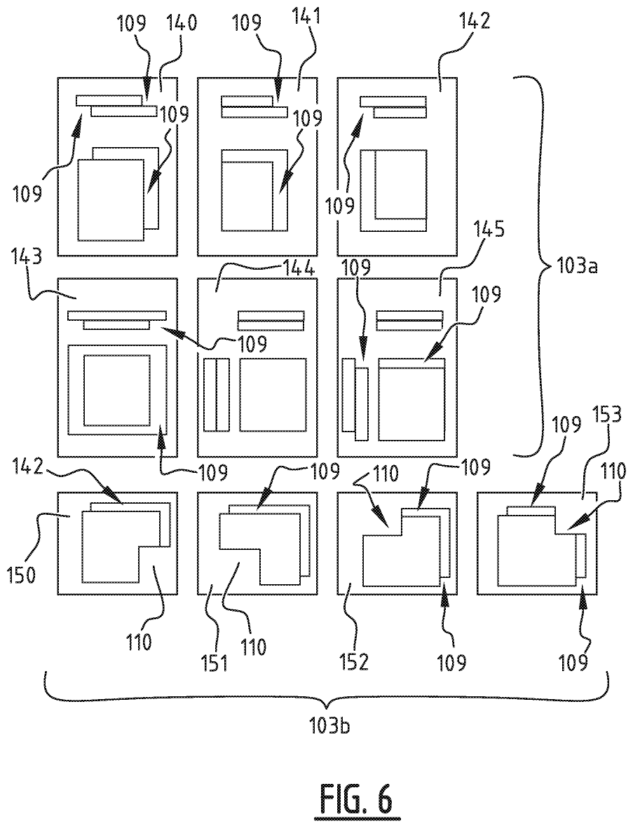

FIG. 6 shows schematically different types of board-like insulating element which can be obtained using the mould of FIGS. 3-5;

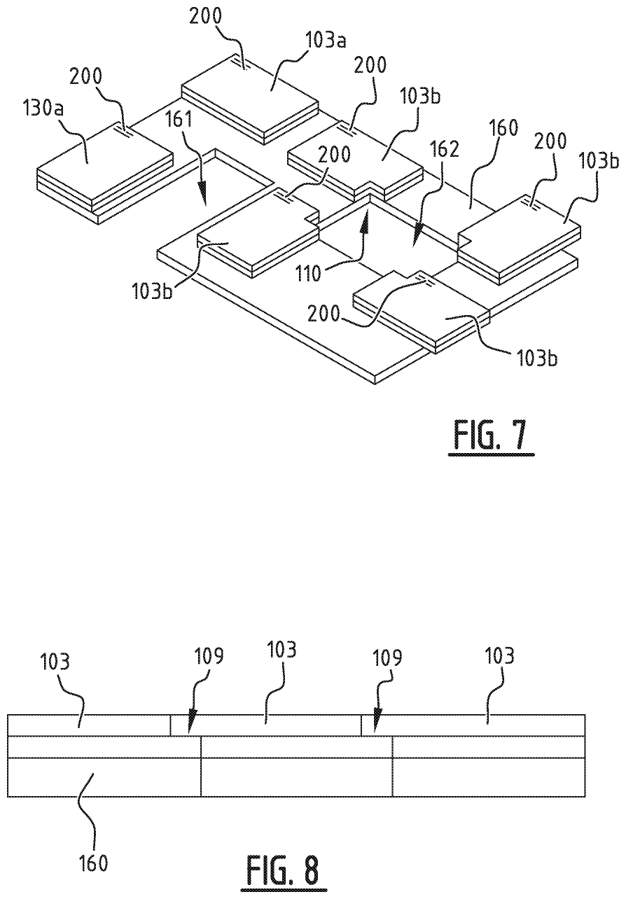

FIG. 7 shows a perspective view of a wall with arranged thereon different types of board-like insulating element manufactured using the mould of the device according to the present invention;

FIG. 8 shows a side view of a wall with board-like insulating elements;

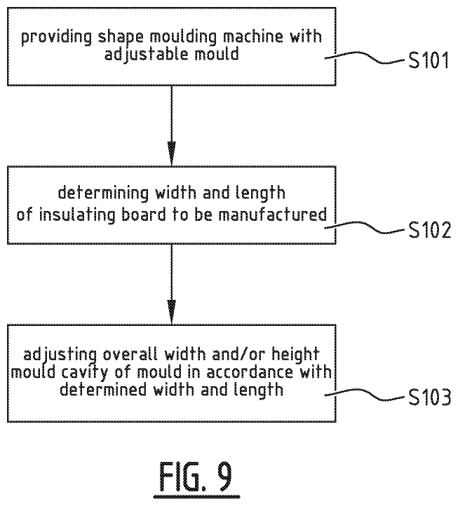

FIG. 9 shows a flow diagram of a preferred embodiment of the method according to the present invention;

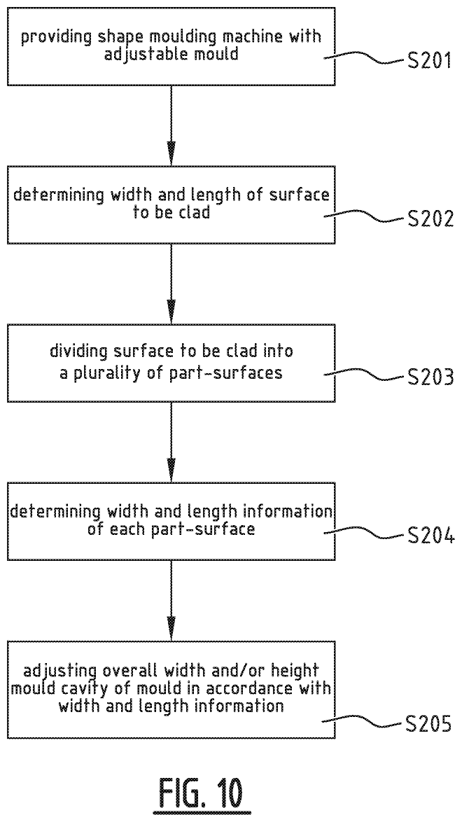

FIG. 10 shows a flow diagram of another preferred embodiment of the method according to the present invention; and

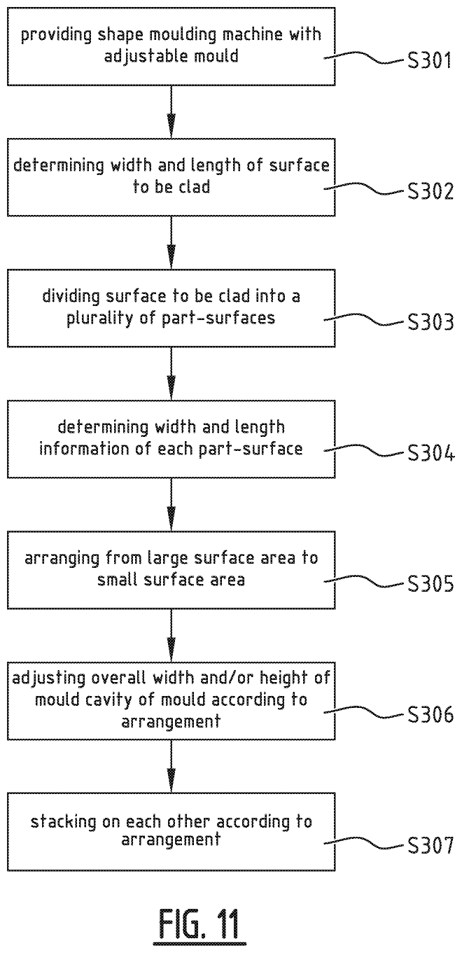

FIG. 11 shows a flow diagram of another preferred embodiment of the method according to the present invention.

FIG. 1 shows a device for manufacturing insulating boards, also known as a shape moulding machine. Shape moulding machine 100 is particularly configured to manufacture boards of expanded polystyrene, also referred to as EPS or styrofoam. For this purpose shape moulding machine 100 comprises a mould 101 with a mould cavity 102 for forming an insulating board 103 therein. Mould cavity 102 has the counter-shape of the product to be manufactured with mould 101, i.e. has a shape which is opposite to the shape of the insulating board 103 to be formed therewith.

The shaping of insulating boards 103 using shape moulding machine 100 takes place as follows. Mould 101 is closed, i.e. two opposite mould halves 104, 105 from which mould 101 is constructed are placed against each other. Pre-expanded polystyrene beads are then arranged in the mould cavity 102 of closed mould 101 under high pressure until mould cavity 102 is completely filled. Steam is then fed to mould cavity 102, whereby the polystyrene beads expand further and fuse into a whole. Air and/or a coolant, such as water, are then used to cool the fused whole of polystyrene beads in order to fixate the shape of the whole which has taken on the form of mould cavity 102. The whole here forms the insulating board 103. After this, mould 101 is opened, i.e. the two opposite mould halves 104, 105 are moved apart. Finally, the shaped insulating board 103 is released from mould 101 and placed on a pallet 106 or on top of an insulating board 103 already placed on pallet 106.

For the purpose of shaping the insulating boards 103 using shape moulding machine 100, the shape moulding machine 100 has two reservoirs 107 for containing the pre-expanded polystyrene beads therein. Each reservoir 107 is funnel-shaped on its lower side, from where an outlet opening is in fluid connection with mould cavity 102 by means of a tube. The pre-expanded polystyrene beads can be introduced into the mould cavity 102 of closed mould 101 via this tube, wherein the shape moulding machine 100 has pressure-generating means to make the insertion of the beads into mould cavity 102 take place under a high pressure. This achieves that the whole mould cavity 102 is filled with the pre-expanded polystyrene beads.

Shape moulding machine 100 further has steam-generating means which are also in fluid connection with the mould cavity 102 of mould 101 via a tube. The steam which is generated by the steam-generating means is introduced into the mould cavity 102 filled with polystyrene beads for further expansion of the beads and for fusing of the beads into one whole. The fused whole is then cooled using cooling means.

Shape moulding device 100 has a control unit, also known as a controller, for controlling the machine 100. This controller controls, among other things, the movement from and to one of the mould halves 104, 105 of the other mould half 104, 105, the feed of the beads to mould cavity 102, the feed of steam to the mould cavity 102 filled with the beads, the feed of air and/or water for discharging heat from the insulating board 103 formed in mould cavity 102 and the release of insulating board 103 from mould cavity 102 of mould 101. Since the mould 101 consists of two mould halves 104, 105 with two internal spaces 111, 112, it is not predetermined in which mould half 104, 105 the shaped insulating board 103 will remain when mould 101 is opened. The manufactured insulating boards 103 also in each case have different dimensions and a different position relative to a central point of mould 101. Use is therefore not made of conventional ejectors on the rear side of one of the mould halves 104, 105, but of means configured especially for this purpose for removing the insulating board 103 from one of the halves 104, 105, such as a vacuum gripper.

The controller is also able to place the manufactured insulating boards 103 in a desired orientation on a pallet 106 or on top of an insulating board 103 already placed on pallet 106.

Finally, the shape moulding machine 100 also has means for providing the shaped insulating board 103 with a text, figure, logo, code or any other legible information 200 which can be arranged on insulating board 103 by means of printing.

FIG. 1 particularly shows schematically an already manufactured insulating board 103 which is manufactured integrally using the mould 101 of shape moulding machine 100. In FIG. 1 a separating line 108 is drawn between the two halves of the thickness of the integrally manufactured insulating board 103 in order to indicate that shape moulding machine 100 is configured to arrange by means of shape moulding one or more rebates 109 having a depth of half the thickness of insulating board 103 in the insulating board.

Reference is in this respect made to FIG. 2, which shows a front view of the shape moulding machine 100 of FIG. 1. In FIG. 2 a rebate 109 can be seen on the right-hand side of insulating board 103, and a rebate 109 on the upper side of insulating board 103. Rebates 109 are thus also located on the left-hand side and the underside (not visible in the front view of FIG. 2) on the rear side of the insulating board 103 shown in FIG. 2. The two geometric halves of insulating board 103 are as it were offset relative to each other. FIG. 2 also shows that insulating board 103 has a recess 110 in its top right corner. This recess 110 can also be formed directly using the mould 101 of shape moulding machine 100. Such a recess 110 makes the insulating board 103 particularly suitable for arranging the insulating board 103 close to a corner point of a window or a door of a prefabricated wall (see also FIG. 7).

FIGS. 3-5 show how such an insulating board 103 can be shaped using shape moulding machine 100 of FIG. 1. These figures show several views of mould 101, particularly the two mould halves 104, 105 from which mould 101 is constructed.

Mould 101 comprises of a fixedly disposed rear mould half 104 and a front mould half 105 which is movable from and to the fixedly disposed rear mould half 104. The front mould half 105 can be moved toward the rear mould half 104 and be placed thereagainst in order to close mould 101 and be moved away from rear mould half 104 in order to open mould 101. Both the rear mould half 104 and the front mould half 105 have an internal space 111, 112 which is bounded by mould walls. In both rear mould half 104 and front mould half 105 these mould walls consist of a large board-like wall 113, 114 extending in the plane of each mould half 104, 105 and wall parts extending perpendicularly thereof and forming a lower wall 115, 119, an upper wall 116, 120 and two side walls 117, 121, 118, 122 which surround the internal spaces 111, 112 of rear mould half 104 and front mould half 105.

During closing of mould 101, i.e. rear mould half 104 and front mould half 105 being moved toward each other and placed against each other, the two internal spaces 111, 112 lie opposite each other, such that these spaces 111, 112 form the mould cavity 102 of mould 101. The mould cavity 102 of mould 101 is therefore formed by the assembly of the two internal spaces 111, 112, these each being bound by their own mould walls.

When mould 101 is closed, the large board-like walls 113, 114 extending in the plane of each mould half collectively form the rear wall 113 and the front wall 114 of the mould cavity 102 composed of the internal spaces 111, 112. The lower wall 115, 119, the upper wall 116, 120 and the two side walls 117, 121, 118, 122 of each mould half 104, 105 collectively form the lower wall 123, the upper wall 124 and the two side walls 125, 126 of the mould cavity 102 composed of the internal spaces 111, 112.

For the position and orientation of the components of mould halves 104, 105 reference is made in the following to the position and orientation as shown in the side view of FIG. 4A.

The rear mould half 104, a cross-sectional side view of which is shown in FIGS. 4A and 5A, has a right side wall 118 which is movable in horizontal direction from and to the left side wall 117. The lower wall 115 is also movable in vertical direction from and to the upper wall 116. The area of movement of the right side wall 118 extends between the right side edge 127 of the rear wall 113 of mould cavity 102 and a right-hand side 128 of a movable segment 129 which is arranged in rear wall 113 and is movable from and to the front wall 114. Likewise, the area of movement of lower wall 115 extends between the lower edge 130 of rear wall 113 and an underside 131 of the movable segment 129 arranged in rear wall 113. The left side wall 117 is for this purpose configured such that it can be moved vertically along the left side edge 132 of rear wall 113 together with the lower wall 115. Lower wall 115 can also be moved horizontally without the left side wall 117 co-displacing horizontally. This makes it possible to position the lower wall 115 such that it bridges the distance between the left side wall 117 and the right side wall 118 on the lower side of internal space 111, such that the lower wall 115 lies against the left side wall 117 and the right side wall 118. Situated under lower wall 115 is a support element 133 which extends partially over the width of the internal space 111. This support element 133 serves to support lower wall 115 in order to ensure a rectangular form of mould cavity 102 on the lower side of mould cavity 102. Upper wall 116 is also movable from and to lower wall 115 in vertical direction over a small range. The area of movement of upper wall 116 extends between the upper edge 134 of rear wall 113 and the upper end 135 of right side wall 118. For the movement of the right side wall 118 and the lower wall 115 the rear mould half 104 comprises respectively two long linear actuators 136, 137 on the right-hand side and one long linear actuator 138 on the underside. For movement of upper wall 116 the rear mould half comprises a short linear actuator 139.

Rear wall 113 further has a plurality of feed ports 190 distributed evenly over rear wall 113 for the purpose of feeding steam to mould cavity 102. The pre-expanded polystyrene beads present in mould cavity 102 hereby expand further and fuse to form one whole. Lower wall 115, upper wall 116, left side wall 117 and right side wall 118 are configured to close the feed ports 190 when they end up lying thereover due to a movement of lower wall 115, upper wall 116, left side wall 117 and/or right side wall 118 which reduces the dimensions of mould cavity 102.

The front mould half 105, a cross-section of which is shown in side view and in perspective view in respective FIGS. 4B and 5B, has the same configuration as the rear mould half 104, but in mirror image. It is thus the case for each of the mould halves 104, 105 that the mould walls thereof, i.e. the lower wall 115, 119, the right side wall 118, 122 and the upper wall 116, 120, are movable to each of their opposite walls. The mould walls of the rear mould half 104 are particularly movable independently and so relative to the mould walls of the front mould half 105. This results in a great variation of ways in which both the size and shape of mould cavity 102 can be adjusted.

Owing to the large area of movement of lower walls 115, 119 and right side walls 118, 122 of the two mould halves 104, 105, mould cavity 102 can be adjusted in two dimensions over a large range using these lower walls 115, 119 and right side walls 118, 122. Mould 101 therefore makes it possible to manufacture insulating boards 103 of many different sizes thereby. A movement of the lower wall 115, 119, the right side wall 118, 122 and/or the upper wall 116, 120 of only one of the rear and the front mould halves 104, 105, i.e. a movement of one or more of said walls of one of the mould halves 104, 105 relative to the walls of the other of the mould halves 104, 105 corresponding therewith, makes it possible also to adjust the mould cavity 102 such that the insulating board 103 to be formed therein comprises a rebate 109 along one or more edges thereof. Since such a rebate 109 need extend over only a small portion of the total dimension of the insulating board 103 to be manufactured, this can already be realized by moving the lower wall 115, 119, the right side wall 118, 122 and/or the upper wall 116, 120 of one of the rear and the front mould halves 104, 105 over a small distance relative to the wall(s) of the other of the mould halves 104, 105 corresponding therewith. Because both the lower wall 115, 119, the right side wall 118, 122 and the upper wall 116, 120 of each of the mould halves 104, 105 is movable, mould 101 provides a great freedom of choice in respect of both the position on insulating board 103 and the width of the rebates 109 to be arranged.

With mould 101 it is possible to manufacture not only substantially rectangular insulating boards 103a, but also substantially L-shaped insulating boards 103b. L-shaped insulating boards 103b are particularly suitable to be arranged adjacently of a wall recess, particularly a wall recess for a window or door to be placed therein. Such L-shaped insulating boards 103b can be manufactured using the mould 101 manufactured using the movable segments 129 which are situated in the top left corner of mould halves 104, 105. The segments 129 can be moved relative to the rear and front wall 113, 114 to respectively the front and rear wall 114, 113 such that the depth of a portion of the mould cavity 102 having a surface area the size of the surface area of segments 129 can be reduced to zero. As a result, a recess 110 is created at the position of segments 129 along the whole thickness of the insulating board 103 to be manufactured.

Using the movable wall parts of both mould halves 104, 105 it is therefore possible to manufacture insulating boards 103 with a great diversity of sizes, optionally with rebates 109 on three different sides of the insulating boards 103 on either the front side or the rear side thereof, wherein the width of the rebates 109 is adjustable. The movable segments 128 in the rear and front walls 113, 114 also enable manufacture of L-shaped boards 103b.

FIG. 6 illustrates different types of insulating board 103 which can be manufactured with the mould 101 shown in FIGS. 3-5. For the purpose of elucidation the integrally manufactured insulating boards 103 are shown with a separating line between the two halves of the thickness. This in order to show that boards 103 from the mould cavity 102 of mould 101 can have rebates 109, which can be realized by a configuration of mould 101 such that wall parts 115-118 of the rear mould half 104 are movable independently and relative to the wall parts 119-122 of the front mould half 105.

FIG. 6 particularly shows six types of substantially rectangular insulating board 103a, i.e. from left to right and from top to bottom:
a first type 140, wherein on the front side, i.e. on the upper side of insulating board 103a, a rebate 109 is arranged on the upper side and the right-hand side, and on the rear side, i.e. the lower side of insulating board 103a, a rebate 109 is arranged on the underside and the left-hand side;
a second type 141, wherein rebates 109 are arranged only on the front side, on the upper side and the right-hand side thereof,
a third type 142, wherein rebates 109 are arranged only on the rear side, on the underside and the left-hand side thereof,
a fourth type 143, wherein rebates 109 are arranged only on the rear side, on the upper side, the left-hand side, the underside and the right-hand side thereof,
a fifth type 144, wherein no rebates are arranged on the sides of insulating board 103a;
a sixth type 145, wherein only one rebate 109 is arranged on the front side, on the upper side thereof.

FIG. 6 further shows four types of L-shaped insulating boards 103b having on the front side thereof, i.e. on an upper side of the insulating board 103b, rebates 109 on the upper side and the right-hand side, i.e. from left to right:
a first type 150 with a recess 110 at bottom right;
a second type 151 with a recess 110 at bottom left;
a third type 152 with a recess 110 at top left; and
a fourth type 153 with a recess 110 at top right;

FIG. 7 shows a perspective view of a prefabricated concrete wall 160 for prefab construction. The concrete wall 160 comprises two recesses 161, 162 for placing respectively a door and a window therein. Arranged on concrete wall 160 are insulating boards 103 manufactured using the mould 101 of FIGS. 3 and 5 of the shape moulding machine 100 shown in FIG. 1. It is clearly visible that parts of concrete wall 160 which have been removed from the door and window recesses 161, 162 are clad with substantially rectangular insulating boards 103a and parts adjacent to said recesses 161, 162 are clad with the L-shaped insulating boards 103b. Although not shown in FIG. 7, insulating boards 103 have rebates 109 on sides against which another insulating board 103 must be arranged. When two insulating boards 103 are placed against each other, an upper portion 170 of an insulating board 103 to be placed overlaps a lower portion 171 of the insulating board 103 which is already in place at the boundary area between the two insulating boards 103. Insulating boards 103 can as it were be arranged on concrete wall 160 in the manner of roof tiles so that heat leaks through the joins 172 between adjacent insulating boards 103 are thereby prevented as far as possible.

FIG. 8 shows a side view of a concrete wall 160 which is covered (clad) with insulating boards 103 provided with rebates 109. It is clearly visible that mutually adjacent insulating boards 103 overlap each other at the position where insulating boards 103 lie against each other.

Since the adjustable mould 101 of shape moulding machine 100 enables manufacture of insulating boards 103 of different sizes and shapes, and rebates 109 can moreover be arranged on different sides of variable width without requiring subsequent machining of the insulating boards 103, little to no cutting waste is created and high-quality insulating boards with edges of high integrity are obtained. The manufacturing process is thereby efficient, and the insulating boards are of high quality. Since the edges are not damaged, this because no further processing is required, the insulating boards 103 of a cladded surface of insulating boards 103 fit together very closely, whereby heat leaks through the joins between adjacent insulating boards 103 are at least substantially wholly prevented.

To limit the cutting waste to a minimum a method is essentially performed as according to the flow diagram as shown in FIG. 9. For this purpose a shape moulding machine with an adjustable mould is firstly provided, this having a mould cavity with an overall width, an overall height and an overall depth which can correspond, optionally after adjustment thereof, with the width, the length and the thickness of the insulating board to be manufactured (S101). Secondly, the width and the length of the insulating board to be manufactured are determined (S102). Finally, the overall width of the mould cavity is adjusted along the overall height and the overall depth of the mould cavity and/or the overall height of the mould cavity is adjusted along the overall width and the overall depth of the mould cavity (S103).

More particularly, the size, the position and the orientation of the insulating board on the surface to be covered/clad therewith, such as the prefabricated wall of FIG. 7, must be known beforehand. In this respect reference is made to the flow diagram of FIG. 10. For this purpose the length, the width and the shape, including recesses, of the surface to be covered/clad are determined (S202). The surface is then geometrically divided into part-surfaces which can be covered by insulating boards which can be manufactured with the mould of the shape moulding machine (S203). For this purpose the length and width of the part-surfaces must respectively not be greater than and not be smaller than respectively the maximum and minimum length and width of the mould cavity of the mould. As stated, the location of recesses in the surface, such as the recesses for a window and a door in the prefabricated wall shown in FIG. 7, must also be known. Ideally, L-shaped insulating boards are placed adjacently of these recesses in order to prevent leaking joins at the position of the corner points of the recesses, while substantially rectangular insulating boards can suffice at positions removed from the recesses. When an optimal geometric division of the surface to be covered/clad into part-surfaces has been obtained, width and length information of each part-surface is determined (S204). Finally, the overall width and/or height of the mould cavity of the mould is adjusted for each part-surface in accordance with the determined width and length information (S205).

In the method according to the flow diagram as shown in FIG. 11 an arrangement of the part-surfaces from large surface area to small surface area is created (S305) after step S304, this corresponding to step S204 of FIG. 10. The overall width and/or height of the mould cavity of the mould are then adjusted according to the created arrangement and in each case in accordance with the determined width and length information (S306). After this, the insulating boards manufactured according to the arrangement are stacked on top of each other according to the arrangement (S307), for instance on a pallet, as shown in FIG. 1. A first significant advantage of working with such an arrangement is that the mould walls of the mould cavity need move in only one direction, i.e. in a direction in which the mould cavity decreases, during manufacture of the different boards. This saves time, which increases the capacity of the shape moulding machine. A second significant advantage of working with the arrangement is that the largest insulating board comes to lie at the bottom of the stack of insulating boards arranged on the pallet and the smallest insulating board at the top of the stack, so that the stack narrows toward the top as seen in the width direction. A stable stack of insulating boards is hereby obtained, which is advantageous during transport thereof.

The shape moulding machine 100 is further provided with printing means, whereby a text 200 can be printed on the front side and an end side of each insulating board 103. In this respect reference is made to FIG. 7, which shows that text 200 is arranged on the front side of each insulating board such that it is legible when insulating board 103 is arranged on prefabricated wall 160 and when wall 160 is viewed in its normal position and orientation. Reference is further made to FIG. 1, which shows that text 200 is likewise arranged on an end side of each insulating board 103 in a stack 180, such that the text 200 of each insulating board 103 in the stack 180 is situated on the same side of stack 180 and is legible when the text 200 of each insulating board 103 is read from a direction perpendicularly of said side of stack 180.

In order to achieve this the shape moulding machine 100 has a controller which determines on the basis of orientation information of the insulating board 103 on the prefabricated wall 160 and orientation information of the insulating board 103 on the stack 180 where and in which orientation the text 200 must be printed on the front and on which end side text 200 must be printed.

It is possible by means of the above discussed shape moulding machine and the method associated therewith to manufacture both substantially rectangular and substantially L-shaped insulating boards of different sizes, optionally with rebates at different locations and of different widths. The shape moulding machine and the associated method thereby enable manufacture of high-quality EPS (styrofoam) insulating boards, i.e. with high shearing and tensile values, without creating cutting waste and without edges becoming damaged, since further processing of the insulating boards is no longer necessary.

The present invention is not limited to the shown embodiments but also extends to other embodiments falling within the scope of protection of the appended claims.

1. Device for manufacturing board-like insulating elements, comprising a mould with a mould cavity for forming a board-like insulating element therein, wherein the mould cavity has an overall width, an overall height and an overall depth which correspond with respectively an overall width, an overall length and an overall thickness of the board-like insulating element, wherein the mould is configured to adjust the overall width of the mould cavity along the overall height and the overall depth of the mould cavity and/or the overall height of the mould cavity along the overall width and the overall depth of the mould cavity.

2. Device according to claim 1, wherein the mould is configured to continuously adjust the overall width of the mould cavity along the overall height and the overall depth of the mould cavity and/or the overall height of the mould cavity along the overall width and the overall depth of the mould cavity.

3. Device according to claim 1 or 2, wherein the mould is configured to reduce the overall width and/or the overall height of the mould cavity to 0% of respectively a maximum overall width and/or a maximum overall height of the mould cavity.

4. Device according to any one of the claims 1-3, wherein the mould is configured to adjust the overall width of the mould cavity along the overall height and only a first portion of the overall depth of the mould cavity and/or the overall height of the mould cavity along the overall width and only a second portion of the overall depth of the mould cavity.

5. Device according to claim 4, wherein a depth dimension of the first portion is equal to a depth dimension of the second portion.

6. Device according to claim 5, wherein each of the depth dimension of the first portion and the depth dimension of the second portion amounts to about 50% of the overall depth.

7. Device according to any one of the claims 1-6, wherein the mould is configured to adjust the overall depth of the mould cavity along the overall width and the overall height of the mould cavity.

8. Device according to claim 7, wherein the mould is configured to continuously adjust the overall depth of the mould cavity along the overall width and the overall height of the mould cavity.

9. Device according to claim 7 or 8, wherein the mould is configured to reduce the overall depth of the mould cavity to about 0% of a maximum overall depth of the mould cavity.

10. Device according to any one of the claims 1-9, wherein the mould is configured to modify a shape of the mould cavity.

11. Device according to claim 10, wherein the mould is configured to modify a shape of the mould cavity such that a recess extending over the total thickness of the board-like insulating element can be arranged in the board-like insulating element.

12. Device according to claim 11, wherein the mould is configured to arrange the recess in a corner of the board-like insulating element so that a substantially L-shaped insulating board is obtained.

13. Device according to any one of the claims 1-12, wherein the mould comprises mould walls with surfaces facing toward the mould cavity, these forming a front wall, a rear wall, a lower wall, an upper wall and two side walls, comprising a left side wall and a right side wall, of the mould cavity, and being arranged such that they collectively form a closed encasement round the mould cavity.

14. Device according to claim 13, wherein at least one of the left side wall and the right side wall is movable such that a relative position of the left side wall and the right side wall is adjustable, such that the overall width of the mould cavity is adjustable by moving the at least one of the left side wall and the right side wall.

15. Device according to claim 13 or 14, wherein at least one of the lower wall and the upper wall is movable such that a relative position of the lower wall and the upper wall is adjustable, such that the overall height of the mould cavity is adjustable by moving the at least one of the lower wall and the upper wall.

16. Device according to any one of the claims 13-15, wherein at least one of the front wall and the rear wall is movable such that a relative position of the front wall and the rear wall is adjustable, such that the overall depth of the mould cavity is adjustable by moving the at least one of the front wall and the rear wall.

17. Device according to any one of the claims 13-16, wherein the front wall and/or the rear wall comprises a movable segment with a segment surface area which is movable relative to a remaining portion of respectively the front wall and/or the rear wall such that a depth of a portion of the mould cavity the size of the segment surface area can be reduced to zero by moving the movable segment.

18. Device according to claim 17, wherein the front wall, the rear wall, the lower wall, the upper wall and the two side walls are arranged movably such that they cannot be positioned in the area of movement of the movable segment.

19. Device according to claim 17 or 18, wherein the movable segment is arranged adjacently of one of the lower wall and the upper wall and one of the two side walls, these being the left side wall and the right side wall, when the lower wall, the upper wall and the two side walls are positioned such that the size of the mould cavity is maximal.

20. Device according to claim 19, wherein the one of the lower wall and the upper wall and the one of the left side wall and the right side wall of which the segment lies adjacently are disposed stationary relative to the other of the lower wall and the upper wall and the other of the left side wall and the right side wall.

21. Device according to any one of the claims 13-20, wherein the mould further comprises:
a first mould half, comprising first mould walls which collectively surround a first cavity forming a first portion of the mould cavity; and
a second mould half comprising second mould walls which collectively form therebetween a second cavity forming a second portion of the mould cavity,
wherein the first mould half and the second mould half are movable relative to each other, such that the mould is movable between respectively an open position, in which the first mould half and the second mould half are mutually separated, and a closed position, in which the first mould half and the second mould lie against each other,
wherein in the closed position the first mould walls and the second mould walls lie against each other such that the first mould walls and the second mould walls collectively form the front wall, the rear wall, the lower wall, the upper wall, the left side wall and the right side wall of the mould cavity and that the first cavity and the second cavity collectively form the mould cavity of the mould,
wherein the first mould walls form the front wall, a first lower wall, a first upper wall and first side walls, comprising a first left side wall and a first right side wall,
wherein the second mould walls form the rear wall, a second lower wall, a second upper wall and second side walls, comprising a second left side wall and a second right side wall, and
wherein the first and the second lower wall collectively form the lower wall, the first and the second upper wall collectively form the upper wall, the first and the second left side wall collectively form the left side wall and the first and the second right side wall collectively form the right side wall.

22. Device according to claim 21, wherein the first mould walls and the second mould walls are movable independently of each other, such that an overall first width and/or an overall first height of the first cavity is adjustable independently of an overall second width and/or an overall second height of the second cavity, and vice versa.

23. Device according to claim 21 or 22, wherein the first mould walls and the second mould walls are movable independently of each other, such that an overall first depth of the first cavity is adjustable independently of an overall second depth of the second cavity, and vice versa.

24. Device according to any one of the claims 21-23, wherein at least one of the first left side wall and the first right side wall and/or at least one of the second left side wall and the second right side wall is movable such that respectively a relative position of the first left side wall and the first right side wall and/or a relative position of the second left side wall and the second right side wall is adjustable, such that respectively the first overall width of the first cavity and/or the second overall width of the second cavity is adjustable.

25. Device according to any one of the claims 21-24, wherein at least one of the first lower wall and the first upper wall and/or at least one of the second lower wall and the second upper wall is movable such that respectively a relative position of the first lower wall and the first upper wall and/or a relative position of the second lower wall and the second upper wall is adjustable, such that respectively the first overall height of the first cavity and/or the second overall height of the second cavity is adjustable.

26. Device according to any one of the claims 21-25, wherein the first lower wall, the first upper wall and the first side walls have the same first dimension as each other in the direction perpendicularly of the front wall, and wherein the second lower wall, the second upper wall and the second side walls have the same second dimension as each other in the direction perpendicularly of the rear wall.

27. Device according to claim 26, wherein the first dimension and the second dimension are the same.

28. Device according to any one of the claims 13-27, wherein the front wall and/or the rear wall comprises a feed opening for feeding steam to the mould cavity.

29. Device according to claim 28, wherein the feed opening comprises a plurality of feed ports distributed substantially evenly over the front wall and/or the rear wall, wherein the feed ports are preferably distributed in a two-dimensional array.

30. Device according to claim 29, wherein the mould walls forming the lower wall, the upper wall, the left side wall and/or the right side wall are configured to close the feed ports which have come to lie outside the mould cavity due to a movement of respectively the lower wall, the upper wall, the left side wall and/or the right side wall which reduces a dimension of the mould cavity.

31. Device according to any one of the foregoing claims, further comprising a controller which is configured to control the mould on the basis of width and length information of the board-like insulating element to be manufactured, such that an overall width and/or an overall height of the mould cavity is adjusted in accordance with the width and length information.

32. Device according to claim 31, wherein the controller is further configured to:
receive width and length information of a plurality of board-like insulating elements to be manufactured;
to create on the basis of the width and length information an arrangement from large surface area to small surface area of the board-like insulating elements to be manufactured; and
to control the mould according to the arrangement such that board-like insulating elements to be manufactured are manufactured from large to small.

33. Device according to claim 32, wherein the controller is further configured to control the device such that board-like insulating elements manufactured according to the arrangement are stacked on top of each other according to this same arrangement, so that the manufactured board-like insulating elements form a stack wherein the surface area of the board-like insulating elements decreases from bottom to top in the stack.

34. Device according to claim 33, wherein the device is further configured to arrange a first label with legible information on a side of each of the board-like insulating elements, and wherein the controller is further configured to control the device such that the first label on the side of each of the board-like insulating elements is arranged such that the first label of each of the board-like insulating elements in the stack lies on the same side of the stack and is legible when the first label of each of the board-like insulating elements is read from a direction perpendicularly of said same side of the stack.

35. Device according to any one of the claims 31-34, wherein the device is further configured to arrange a second label with legible information on a front side of the board-like insulating element, and wherein the controller is further configured to:
receive first orientation information about a first orientation of a surface to be clad with the board-like insulating element and to receive second orientation information about a second orientation of the board-like insulating element relative to the surface to be clad with the board-like insulating element and on which the board-like insulating element is to be arranged; and
to control the device on the basis of the first and the second orientation information such that the label and the front side of the board-like insulating element are oriented relative to each other, and the label is then arranged on the front side of the board-like insulating element, such that in a state wherein the board-like insulating element is arranged according to the second orientation on the surface to be clad the label is legible when the surface to be clad is oriented according to the first orientation and the second label is read from a direction perpendicularly of the surface to be clad.

36. Device according to claim 35, wherein the surface to be clad is a wall of a building.

37. Device according to claim 36, wherein the wall is a prefabricated wall.

38. Device according to any one of the foregoing claims, wherein the board-like insulating elements are insulating boards manufactured from expanded polystyrene (EPS).

39. Device according to any one of the foregoing claims, wherein the device is a shape moulding machine.

40. Method for manufacturing board-like insulating elements, comprising of:
providing a device for manufacturing board-like insulating elements, comprising a mould with a mould cavity for shaping a board-like insulating element therein, wherein the mould cavity has an overall width, an overall height and an overall depth which correspond with respectively a width, a length and a thickness of the board-like insulating element;
determining the width and the length of the board-like insulating element to be manufactured;
adjusting the overall width of the mould cavity along the overall height and the overall depth of the mould cavity and/or overall height of the mould cavity along the overall width and the overall depth of the mould cavity in accordance with the determined width and length of the board-like insulating element to be manufactured; and
manufacturing the board-like insulating element in the adjusted mould cavity.

41. Method according to claim 40, wherein the mould is configured to adjust the overall width of the mould cavity along the overall height and only a first portion of the overall depth of the mould cavity and/or the overall height of the mould cavity along the overall width and only a second portion of the overall depth of the mould cavity, wherein a depth dimension of the first portion corresponds with a depth of a first rebate to be arranged in a length direction of the insulating element and a depth dimension of the second portion corresponds with a depth of a second rebate to be arranged in a width direction of the insulating element, and wherein the method further comprises of:
determining a width of the first rebate and/or determining a length of the second rebate; and
adjusting the mould respectively in accordance with the determined width of the first rebate and/or in accordance with the determined length of the second rebate.

42. Method according to claim 41, wherein the depth dimension of the first portion is equal to the depth dimension of the second portion so that the depth of the first rebate is equal to the depth of the second rebate.

43. Method according to claim 42, wherein each of the depth dimension of the first portion and the depth dimension of the second portion amounts to about 50% of the overall depth, so that the depth of the first rebate and the depth of the second rebate amounts to about 50% of the thickness of the board-like insulating element.

44. Method according to any one of the claims 40-43, wherein the mould is configured to adjust the overall depth of the mould cavity along the overall width and the overall height of the mould cavity, and wherein the method further comprises of:
determining the thickness of the board-like insulating element to be manufactured; and
adjusting the overall depth of the mould cavity along the overall width and the overall height of the mould cavity in accordance with the determined thickness of the board-like insulating element to be manufactured.

45. Method according to any one of the claims 40-44, wherein the mould is configured to modify a shape of the mould cavity, wherein the method further comprises of:
determining a shape of the board-like insulating element to be manufactured; and
modifying the shape of the mould cavity in accordance with the determined shape of the board-like insulating element to be manufactured.

46. Method according to claim 45, wherein the step of modifying the shape of the mould cavity in accordance with the determined shape of the board-like insulating element to be manufactured comprises of:
modifying the shape of the mould cavity such that a recess is arranged in the board-like insulating element which extends over the total thickness of the board-like insulating element.

47. Method according to claim 46, wherein the recess is arranged in a corner of the board-like insulating element so that a substantially L-shaped insulating board is obtained.

48. Method according to claim 46 or 47, wherein the recess is obtained by arranging an element in the mould cavity which locally reduces the depth of the mould cavity to zero.

49. Method according to any one of the claims 40-48, wherein the step of determining the width and the length of the board-like insulating element to be manufactured comprises of:
determining a width, a length and a shape of a surface to be clad with the board-like insulating elements;
geometrically dividing the whole surface to be clad into a plurality of part-surfaces, wherein a width and a length of each of the plurality of part-surfaces are respectively not greater than and not smaller than respectively a maximum insulating element width and a maximum insulating element length and respectively a minimum insulating element width and a minimum insulating element length of an insulating element to be manufactured in the mould cavity of the mould; and
for each of the plurality of part-surfaces:
determining width and length information; and
determining the width and the length of the board-like insulating element to be manufactured in accordance with the determined width and length information.

50. Method according to claim 49, further comprising of:
creating an arrangement from large surface area to small surface area of the part-surfaces of the plurality of part-surfaces following the step of determining the width and the length information for each of the plurality of part-surfaces; and
according to the arrangement and in each case in accordance with the determined width and length information:
adjusting the overall width of the mould cavity along the overall height and the overall depth of the mould cavity and/or overall height of the mould cavity along the overall width and the overall depth of the mould cavity; and
manufacturing the board-like insulating element in the adjusted mould cavity.

51. Method according to claim 50, further comprising of:
stacking the board-like insulating elements manufactured according to the arrangement on top of each other according to the arrangement, so that the manufactured board-like insulating elements form a stack wherein the surface area of the board-like insulating elements decreases from the bottom to the top of the stack.

52. Method according to claim 51, further comprising of:
arranging a first label with legible information on a side of each of the board-like insulating elements, comprising of:
arranging the first label on the side of each of the board-like insulating elements such that the first label of each of the board-like insulating elements in the stack lies on the same side of the stack and is legible when the first label of each of the board-like insulating elements is read from a direction perpendicularly of said same side of the stack.

53. Method according to any one of the claims 40-52, further comprising of:
arranging a second label with legible information on a front side of the or each board-like insulating element, comprising of:
obtaining first orientation information about a first orientation of a surface to be clad with the or each board-like insulating element and second orientation information about a second orientation of the or each board-like insulating element relative to the surface to be clad with the or each board-like insulating element and on which the or each board-like insulating element is to be arranged; and
orienting the second label and the front side of the or each board-like insulating element relative to each other, and then arranging the second label on the front side of the or each board-like insulating element, on the basis of the first and the second orientation information such that in a state wherein the or each board-like insulating element is arranged on the surface to be clad according to the second orientation the second label is legible when the surface to be clad is oriented according to the first orientation and the second label is read from a direction perpendicularly of the surface to be clad.

54. Method according to claim 53, wherein the surface to be clad is a wall of a building.

55. Method according to claim 54, wherein the wall is a prefabricated wall.

56. Method according to any one of the claims 40-55, wherein the board-like insulating elements are insulating boards manufactured from expanded polystyrene (EPS).

57. Method according to any one of the claims 40-56, wherein the device is a shape moulding machine.

58. Use of the device according to any one of the claims 1-39 in the manufacture of board-like insulating elements using the method according to any one of the claims 40-57.
